(19) United States
(12) Patent Application Publication
(10) Pub. No.: US 2007/0224352 A1
(43) Pub. Date: Sep. 27, 2007

(54) Powder Coating Procedures

(76) Inventor: Jeffrey William Stewart, Auckland (NZ)

Correspondence Address: JACOBSON HOLMAN PLLC, 400 SEVENTH STREET N.W., SUITE 600, WASHINGTON, DC, 20004, US

(21) Appl. No.: 10/576,739

(22) PCT Filed: Oct. 13, 2004
(86) PCT No.: PCT/NZ04/00250

§ 371 Date: Mar. 12, 2007

(30) Foreign Application Priority Data
Oct. 21, 2003 (NZ) 529056
Mar. 8, 2004 (NZ) 531623
Aug. 9, 2004 (NZ) 529056/531623

(51) Int. Cl. B05D 3/02

(52) U.S. Cl. 427/314

(57) ABSTRACT

A method of coating a substrate such as a heat sensitive engineered wood substrate which involves sequential powder coating where at least one and preferably both powder coating steps involves the use of fixed infrared heat sources (optionally pulsing themselves) passed which the developing product (the substrate and its coatings) moves thereby to provide a heat relaxation between maximum exposure to each (optionally pulsing) infrared source. Preferably the first coating is green cured only prior to the application of the second powder coating. Preferably similar pulsing heat sources are used for the initial heating of the substrate so as to enable powder coating.

### TECHNICAL FIELD

The present invention relates to methods of powder coating heat sensitive substrates, products that result from such methods, heat sensitive substrates powder coated in two layers and related methods, products, sub-assemblies and assemblies.

A range of heat sensitive substrates are encountered which require an effective surface coating.

Existing surface coating regimes that rely upon powder coating are those hereinafter shown in FIGS. 1 and 2. Each involves either preheating (either with radiant infrared or with convection heat or combination of both) or the application of a liquid primer coating prior to the presentation of the powder coating thereto.

### BACKGROUND

PCT/EP96/03264 of MIDASLR (published as W097/05965) discloses a method for coating surfaces in general, and decorating them with powders of various colours characterised by: applying to the surface to be decorated, previously treated for this application, a layer of powdered coating material of colour corresponding to the desired background for the decoration to be obtained, heating the surface treated in this manner to a temperature lower than the backing temperature of the powdered coating material, but sufficient to fix it to the surface to be decorated, applying to the surface prepared in this manner at least one powder of colour corresponding to the coloured motif to be reproduced, distributing it in accordance with the desired pattern of this motif, subjecting the surface treated in this manner to final baking for a time and at a temperature sufficient to securely fix said powder to said surface.

W097/05965 whilst speaking in respect of a heating temperature for at least the preliminary powder coating of from 75 to 90° C. is silent as to how this can be achieved other than to refer to a traditional powder coating line having pairs of catalytic heating panels, heating lamps, ultraviolet lamps, etc between which the two surfaces to be decorated is passed.

The present invention recognises an advantage for heat sensitive substrates where a conveyor advance of a product can be passed plural infrared sources thereby, in each passage passed the plural sources, to elicit a desirable effect but with the temperatures being controllable by the relativity of the conveyor speed to the intensity and output of each infrared source and the spacing of them mutually apart. In addition, there is also seen an advantage, for the purpose of temperature control, of having one or more of the infrared sources controlled as to output-by, for example, its own pulsing of its maximum output.

Thereafter one prior art regime cures the thus applied powder coating with infrared radiation and/or with convention heat thereby to provide the coated component.

Another procedure relies upon thermal melting and flowing of the powder coat reliant on infrared radiation and/or convection heat and thereafter a UV curing step thereby to provide the coating component.

Such prior art procedures provide adequate coatings for many substrates but not for heat sensitive substrates which present gassing difficulties and/or are liable to damage owing to the heats that may be required by such processes. Difficulties can compound at edges and profiled regions.

As used herein “heat sensitive substrates” (“HSS”) include any substrate of a kind where such conventional processes tend to be less than optimal. One such substrate is that frequently referred to as “engineered wood substrates” (“EWS”) typified plywood by many resin bound lignocellulosic fibrous composites (e.g. MDF, particle board, OSB, LBL, etc.) or even some such compositions not requiring an added resin system (e.g. hardboard). Other heat sensitive fibres include carbon fibres. Such carbon fibre/resin systems can be degraded as far as strength is concerned is subjected to excessive heats. Other heat sensitive substrates (“HSS”) include any less tolerant to temperature than, say, EWS or as intolerant to temperature as EWS.

As used herein “powder coating” includes or refers to any procedure where electrostatic attachment of a coating material (“powder”) is involved irrespective of whether or not the coating material is in a solids and/or liquid form (a true powder) prior to any cure or drying thereof.

As used herein the term “and/or” means “and” or “or” or, where permitted by the context, both.

As used herein the term “(s)” following a noun means either or both the singular and plural forms of that noun.

Reference herein to a “powder” (subject to the foregoing comment in respect of powder coating) preferably includes any powder of a kind capable of at least a partial cure under the action of heat such as that derived from an IR (infrared) source and in the case of the second powder coating a powder both or either capable of being cured by a IR heating source and/or melted and/or melded with an IR heating source and being cured in that molten and/or the post molten state under the action of a UV source.

Reference herein to “preheating” is preferably (but not necessarily) to ensure sufficient conductivity for subsequent powder deposition reliant on electrostatic attachment. Likewise partial cure heating, etc.

As used herein “cure” (and related words such as “curing”) includes polymerisation, etc. or other chemical reformation, irrespective of whether or not to completion.

As used herein the terms “pulse” or “pulsed” mean, in respect of exposure to infrared radiation, subjection to oscillating heat and relaxation periods (“Oscillating Relaxation Periods” or “ORP”). During the relaxation period or periods (arising from movement relative to plaques, or vice versa, rather than heating control of the plaques) the energy absorbed by the coating (immediate surface of the product exposed) is allowed to uniformly disperse across the previously irradiated surface e.g as shown in FIG. 5 as opposed to FIG. 4 hereof. Nonetheless, prior art type pulsing plaques can be used (and preferably are used), in addition, to provide some semblance of heating control for the non relaxation periods (e.g as in FIG. 6).

“ORP” includes both the singular or plural.

The present invention recognises an advantage to be derived from a sequential coating procedure.

### BRIEF DESCRIPTION OF THE INVENTION

In one aspect the invention is a method of coating a substrate to provide a product which comprises or includes the steps of

heating the substrate sufficiently to enable its powder coating,

applying a coating of a powder (“the first powder coating”) to the sufficiently heated substrate,

at least partially heat curing the first powder coating,

applying a subsequent powder coating (whether the same powder or different) (“the second powder coating”) to the at least partially cured and still sufficiently heated first powder coating, and

heat curing the second powder coating,

wherein the at least partial curing of first powder coating and/or the curing of the second powder coating involves movement of a surface of the substrate or coated substrate relative to plural infrared (“IR”) radiant heat sources thereby to provide a pulsing of exposure to the maximum heating effect of each heat source irrespective of whether or not one or more of such heat sources itself or themselves pulse its or their infrared output.

Preferably the curing of the second powder coating involves movement relative to plural infrared radiant heat sources.

Preferably the curing of the second powder coating completes the curing of the first powder coating.

Preferably at least one of the heat sources itself is a pulsing infrared radiant heat source.

Preferably the relative movement is continuous.

Alternatively, but less preferred, the relative movement is intermittent.

Most preferably the heating of the substrate is with an infrared radiant heat source or sources and there is movement of the substrate relative thereto.

Preferably the infrared radiant heat sources are stationary.

Preferably the substrate and developing product is carried by a conveyor.

Preferably a majority of said heating, at least partial heat curing and heat curing involves pulsing infrared heat sources passed which the substrate or developing product is carried.

In another aspect the invention is a method of coating a heat sensitive substrate which comprises or includes the steps of

pre-heating the heat sensitive substrate,

applying a first coating of a powder,

at least partially curing the powder coating,

applying a subsequent powder coating (whether the same powder or different) (“the second powder coating”) over the at least partially cured first powder coating, and either

(i) curing the second powder coating, or

(ii) causing the melting and flowing of the second powder coating and thereafter UV curing that coating.

wherein at least one of the pre-heating, at least partial curing and curing steps involves presentation to spaced infrared (“IR”) sources (e.g thereby to provide a pulsing of IR exposure).

Preferably the IR sources are intermittent or variable in output.

In still another aspect the invention is a method of coating a heat sensitive substrate which comprises or includes the steps of

pre-heating with infrared heating the surface of the heat sensitive substrate,

applying a first coating of a powder to the heated surface,

at least partially curing the first powder coating with infrared heating,

applying a subsequent powder coating (whether the same powder or different) (“the second powder coating”) over at least the partially, cured first powder coating, and either

(i) infrared curing the second powder coating, or

(ii) (a) causing with infrared heating the melting and flowing of the second powder coating, and
(b) thereafter UV curing that coating,

wherein at least one of the infrared heating steps involves movement relative to spaced infrared sources.

Preferably at least one or the infrared sources pulses or varies in output.

In another aspect the invention is a method of coating engineered wood substrate which comprises or includes the steps of

pre-heating the heat sensitive substrate,

applying a first coating of a powder,

at least partially infrared radiation curing the powder coating,

applying a subsequent powder coating (whether the same powder or different) (“the second powder coating”), and

infrared radiation curing the second powder coating,

wherein each of said infrared radiation steps involves spaced infrared radiation sources.

Preferably at least some of such sources pulse or vary in output.

The use of spaced IR heat sources spaced relative to a conveying direction to treat each of two powder applications to a heat activated substrate.

Preferably said spaced IR heat sources pulse in output.

Any product being a substrate coated by a method or as a result of a use.

As a product, any product that includes at least in part a heat sensitive substrate that has been coated by two layers, a first layer being of a powder coating, and the second layer being of a powder coating, the coating procedure has been characterised in that:

the substrate was preheated prior to the application of the first coating of powder and such preheating was with a IR heating source and/or otherwise with a heating source controlled to provide sufficient heating for the purpose (e.g. to enable powder retention) without any substantial damage to the substrate,

the first coating of powder is at least partially cured under the action of at least one controlled IR heating source thereby to reduce damage to the heat sensitive substrate, and

the second powder coating is either cured by at least one controlled infrared heating source or a combination of at least one controlled infrared heating source and a source of UV,

wherein the control has in at least one case required the use of spaced and/or pulsing IR sources.

In still another aspect the invention is a product of an engineered wood substrate or at least in part of an engineered wood substrate wherein the substrate, prior to any coating, has been subjected to surface heating to achieve at least some measure of heat induced degassing thereof and heat activation of the surface, and thereafter at least two powder coating layers have been applied with the innermost layer being at least partially cured reliant on infrared heating prior to application of any further layer(s) and the subsequent layer or subsequent layers being cured by infrared heating or a combination of infrared heating and UV radiation.

In still another aspect the invention is a coating on a heat sensitive substrate which is or was a green or partially cured powder coat having thereover a subsequently applied and cured powder coating, the cured powder coating having been powdered over the first coating subsequent to at least a partial curing thereof.

In still another aspect the invention is a coated substrate, said substrate optionally being heat sensitive,

wherein the coating has been of at least two powder applications,

and wherein the first powder application prior to the powder application of its contiguous layer was green cured,

and wherein the combined coatings have been subjected to the heat from intermittent or varying infrared sources thereby to provide at least melting and flowing of the outer layer, and, optionally, some further curing of the inner layer.

The invention is also a product of a method of the present invention.

In another aspect the present invention consists in a method of coating a heat sensitive substrate which comprises or includes the steps of

pre-heating the heat sensitive substrate,

applying a first coating of a powder,

at least partially curing the powder coating,

applying a subsequent powder coating (whether the same powder or different) (“the second powder coating”), and either

(i) curing the second powder coating, or

(ii) (a) causing the melting and flowing of the second powder coating, and
(b) UV curing that coating.

Preferably in one or more of the pre-heating, partial curing and curing steps infrared radiation is used serially or intermittently so as to provide temperature relaxation (preferably ORP).

In one option step (i) is used.

In another option step (ii) is used.

Preferably step (ii)(b) at least substantially follows step (ii)(a).

Optionally and preferably the preheating is with infrared heat (optionally with ORP)

Preferably the at least partial cure of the first coating is “green curing”.

As used herein “green curing” means melt, flow and partial curing.

Optionally such at least partial cure is with infrared radiant heat in, for example, an IR oven preferably with ORP.

The powder(s) used can be any of those used with acknowledged prior art procedures.

Preferably the second powder coating is of a similar powder to that of the first powder coating, but can be different and/or include different additives and/or modifiers.

In one option (option (i)) the second powder coating is heat cured reliant upon infrared radiant heat preferably with ORP.

Preferably said infrared radiant heat is intermittent (pulses) or variable from its plaques. Preferably the plaques are spaced so as to provide oscillating relaxation periods (“ORP”) even though we preferably use an IR oven with pulsing plaques.

In another variant, i.e. option (ii), infrared radiant heat [optionally intermittent or variable] (preferably with ORP, for example, in an infrared oven with a series of spaced pulsing plaques) is used to melt and flow the second powder coating prior to UV curing thereof.

In still another aspect the present invention consists in a method of coating a heat sensitive substrate which comprises or includes the steps of

pre-heating the heat sensitive substrate,

applying a first coating of a powder,

partially curing the powder coating,

applying a subsequent powder coating (whether the same powder or different) (“the second powder coating”) over the partially cured first powder coating, and either

(i) curing the second powder coating, or

(ii) causing the melting and flowing of the second powder coating and thereafter UV curing that coating.

Preferably at least one, two or more of the pre-heating, partial curing and final curing steps involved IR irradiation of a pulsed and/or having an ORP character.

Optionally and preferably the preheating is with infrared heat.

Optionally such partial cure is with infrared radiant heat in, for example, an IR oven (optionally with pulsing plaques) preferably with ORP.

Preferably the second powder coating is of a similar powder to that of the first powder coating.

In one option (option (i)) the second powder coating is heat cured reliant upon infrared radiant heat preferably with ORP.

Preferably said infrared radiant heat is intermittent or variable. Preferably has ORP (preferably using an IR pulse plaque oven).

In another variant, i.e. option (ii), infrared radiant heat [optionally intermittent or variable] (preferably with ORP, for example, in an infrared pulse plaque oven) is used to melt and flow the second powder coating prior to UV curing thereof.

In another aspect the present invention consists in a method of coating a heat sensitive substrate which comprises or includes the steps of

pre-heating with infrared heating the surface of the heat sensitive substrate (preferably with ORP),

applying a first coating of a powder to the heated surface,

at least partially curing the first powder coating with infrared heating (preferably with ORP),

applying a subsequent powder coating (whether the same powder or different) (“the second powder coating”) over at least the partially cured first powder coating, and either

(i) infrared curing the second powder coating (preferably with ORP), or

(ii) (a) causing with infrared heating (preferably with ORP) the melting and flowing of the second powder coating, and
(b) thereafter UV curing that coating.

Preferably the at least partial cure of the first coating is “green curing”.

Preferably the second powder coating is of a similar powder to that of the first powder coating.

In one option (option (i)) the second powder coating is heat cured reliant upon intermittent or varying infrared radiant heat plaques staged so also to provide ORP.

Preferably it is pulsed (preferably using an IR pulse oven).

In another variant, i.e. option (ii), infrared radiant heat [optionally intermittent or variable] (preferably pulsed, for example, in an infrared pulse oven) is used to melt and flow the second powder coating prior to UV curing thereof

In a further aspect the present invention consists in a method of coating engineered wood substrate which comprises or includes the steps of

pre-heating the heat sensitive substrate,

applying a first coating of a powder,

at least partially curing the powder coating,

applying a subsequent powder coating (whether the same powder or different) (“the second powder coating”), and either

(i) curing the second powder coating, or

(ii) (a) causing the melting and flowing of the second powder coating and
(b) thereafter UV curing that coating.

Preferably step (ii)(b) at least substantially follows step (ii)(a).

Optionally and preferably the preheating is with infrared heat preferably with ORP.

Preferably the at least partial cure of the first coating is “green curing”.

Optionally such at least partial cure is with infrared radiant heat in, for example, an IR oven preferably with ORP.

Preferably the second powder coating is of a similar powder to that of the first powder coating.

In one option (option (i)) the second powder coating is heat cured reliant upon infrared radiant heat.

Preferably said infrared radiant heat is intermittent or variable so as to provide ORP. Preferably it is pulsed (preferably using an IR pulse oven).

In another variant, i.e. option (ii), infrared radiant heat [optionally intermittent or variable preferably with ORP] (preferably ORO, for example, in an infrared pulse plaque oven) is used to melt and flow the second powder coating prior to UV curing thereof.

In yet a further aspect the present invention consists in a method of coating an engineered wood substrate which comprises or includes the steps of

(A) pre-heating the heat sensitive substrate,

(B) applying a first coating of a powder,

(C) at least partially curing the powder coating,

(D) applying a subsequent powder coating (whether the same powder or different) (“the second powder coating”), and

(E) either
(i) curing the second powder coating, or
(ii) (a) causing the melting and flowing of the second powder coating and
   (b) thereafter UV curing that coating,

wherein at least one or more of steps (A), (C), (E) [(i) or (ii)(a)] uses infrared heating which optionally [and preferably] is intermittent or varying so as to cause the desired outcome(s), i.e. without any substantial damage to the substrate. Preferably ORP heating regime(s) is (are) used.

Optionally and preferably the preheating is with infrared heat.

Preferably the at least partial cure of the first coating is “green curing”.

Optionally such at least partial cure is with infrared radiant heat in, for example, an IR oven.

Preferably the second powder coating is of a similar powder to that of the first powder coating.

In one option (option (i)) the second powder coating is heat cured reliant upon infrared radiant heat.

Preferably said infrared radiant heat is intermittent or variable. Preferably it is pulsed (preferably using an IR pulse oven).

In another variant, i.e. option (ii), infrared radiant heat [optionally intermittent or variable] (preferably ORP, for example, in an infrared pulse oven) is used to melt and flow the second powder coating prior to UV curing thereof.

In still another aspect the present invention consists in a method of coating a heat sensitive substrate which comprises or includes the steps of

(A) pre-heating the heat sensitive substrate,

(B) applying a first coating of a powder,

(C) at least partially curing the powder coating,

(D) applying a subsequent powder coating (whether the same powder or different) (“the second powder coating”), and

(E) either
(i) curing the second powder coating, or
(ii)(a) causing the melting and flowing of the second powder coating, and
   (b) thereafter IN curing that coating,

wherein at least one or more of steps (A), (C), (E) [(i) or (ii)(a)] uses infrared heating which optionally [and preferably] is intermittent or varying so as to cause the desired outcome(s), i.e. without any substantial damage to the substrate. Preferably ORP heating regime(s) is (are) used.

Optionally and preferably the preheating is with infrared heat.

Preferably the at least partial cure of the first coating is “green curing”.

Optionally such at least partial cure is with infrared radiant heat in, for example, an IR oven.

Preferably the second powder coating is of a similar powder to that of the first powder coating.

In one option (option (i)) the second powder coating is heat cured reliant upon infrared radiant heat.

Preferably said infrared radiant heat is intermittent or variable.

Preferably it is pulsed to provide ORP (preferably also using IR pulse oven plaques).

In another variant, i.e. option (ii), infrared radiant heat [optionally intermittent or variable] (preferably to provide, for example, in an infrared pulse plaque oven) is used to melt and flow the second powder coating prior to UV curing thereof.

In a further aspect the present invention consists in the use of pulsed (i.e to provide ORP) (or varying or intermittent) IR heat to treat each of two powder applications to a heat activated substrate (optionally with LW curing of the outer layer).

In a further aspect the present invention consists in any product being a substrate coated by a method or in a use in accordance with the present invention.

In yet a further aspect the present invention consists in, as a product, any product that includes at least in part a heat sensitive substrate that has been coated by two layers, a first layer being of a powder coating, and the second layer being of a powder coating, the coatings being characterised in one or more of the following:

(a) the substrate was preheated prior to the application of the first coating of powder and such preheating was with a IR heating source and/or otherwise with a heating source controlled to provide sufficient heating for the purpose (e.g. to enable powder retention) without any substantial damage to the substrate,

(b) the first coating of powder is at least partially cured and preferably green cured preferably under the action of a controlled preferably IR heating source thereby to reduce damage to the heat sensitive substrate,

(c) the second powder coating is either cured by a controlled infrared heating source or a combination (preferably first) of a controlled infrared heating source and a source of UV.

Preferably at least one IR heating is to provide an ORP regime.

In still a further aspect the present invention consists in a product of an engineered wood substrate or at least in part of an engineered wood substrate wherein the substrate, prior to any coating, has been subjected to surface heating to achieve at least some measure of heat induced degassing thereof and heat activation of the surface, and thereafter at least two powder coating layers have been applied with the innermost layer being at least partially cured reliant on infrared heating prior to application of any further layer(s) and the subsequent layer or subsequent layers being cured by infrared heating or a combination of infrared heating and UV radiation.

Preferably at least one IR heating is to provide an ORP regime.

In still a further aspect the present invention consists in a coating on a heat sensitive substrate which is or was a green or partially cured powder coat having thereover a subsequently applied and cured powder coating, the cured powder coating having been powdered over the first coating subsequent to at least a partial curing thereof.

Preferably the curing of the subsequently applied layer has the effect of further curing the initial layer.

Preferably at least one (and preferably more) of the preheating, at least partial curing and curing steps has involved at least in part infrared (optionally intermittent and/or varying infrared).

In another aspect the invention consists in a coated substrate, said substrate optionally being heat sensitive,

wherein the coating has been of at least two powder applications,

and wherein the first powder application prior to the powder application of its contiguous layer was green cured,

and wherein the combined coatings have been subjected to the heat from at least intermittent or varying infrared sources thereby to provide at least melting and flowing of the outer layer, and, optionally, some further curing of the inner layer.

Preferably the inner layer was dusted to a thickness of from 20 to 60 microns (preferably 30-40 microns) and the subsequent layer was dusted to about 40 to 80 microns thick over the residue of the inner layer [preferably to a total thickness of from 60 to 140 microns].

Optionally, the outer layer can be UV cured.

In another aspect the invention is a coating procedure which involves at least one of curing or partial curing with ORP in a sequenced powder coating regime.

### BRIEF DESCRIPTION OF THE DRAWINGS

A preferred form of the present invention will now be described with reference to the accompanying drawings in which,

FIG. 1 shows a prior art powder coating procedure when being used less than optimally with a heat sensitive substrate,

FIG. 2 like FIG. 1 shows a conventional powder coating procedure being used less than optimally with a heat sensitive substrate,

FIG. 3 shows processes of the present invention,

FIG. 4 shows Temperature (T) build up in a conventional IR pulse plaque oven,

FIG. 5 shows (e.g with two relaxation periods by way of example) the lesser T build up using (preferably pulsed IR plaques) serially separated so as to provide relaxation periods, and

FIG. 6 is a flow diagram showing as the powder coated product passes through the IR the product is subjected to oscillating heat and relaxation periods. During the relaxation period the energy absorbed by the coating (immediate surface of the product) is allowed to uniformly disperse across the previously irradiated surface.

### DETAILED DESCRIPTION OF THE INVENTION

The following for the type of powder coatings can be used for either or both coatings and are preferably of the resin/binder type. These include powder coatings based on the following resin chemistries (including variations thereof, and not limited to):
Polyester
Epoxy
Epoxy Polyester
Polyester - hydroxyalkylamide
Polyurethane
Acrylic
Epoxy-Acrylate
Acrylo-Polyurethane
Acrylo-Polyester.

Additionally they can include powder coatings that may contain flexibility modifying additives for example those based on core/shell acrylic rubber.

When processing HSS we have found it preferably to use a heating source that is controllable and directly able in which to localise and thus minimise heat transfer into the substrate but make it conductive enough to powder coat evenly.

To solve this problem we have evolved two techniques of advantage in the procedures of the present invention.

1. Dual Coating (2 stage application—optionally single or double pass)

2. Electromagnetic Radiation Pulsing (ERP), preferably IR with ORP or ORPs.

Process Overview:

The process involves the pre-conditioning of the substrate which in one embodiment is an engineered wood substrate (EWS). This is achieved by way of applying a minimum level of heat to increase conductivity of the EWS, whilst not unduly diminishing its physical integrity.

A first “dusting” layer of powder of a powder coating system is applied to the EWS (approximately 30-40 microns), this is then followed by a “green cure” (i.e. melt, flow & partial curing) of the dusting layer by way of an IR heating, which blocks off and seals the EWS.

A secondary coat of powder coating is then applied (approximately 50-60 microns) over the dusting coat.

The final thickness of the powder coating, then being approximately 80-100 microns, which is then cured to the specification required.

The final curing preferably ensures (e.g with ORP) that the EWS does not receive too high a level of IR heat input. This involves only allowing just enough heat be absorbed by the powder coating so as to polymerise it to the level specified. Too much heat will result in off-gassing, cracking and degradation of the EWS, which will lead to post cure cracking (PCC) and loss of the EWS mechanical properties such as “screw-ability”.

A Preferred Procedure:

The EWS is preferably loaded on to the coating conveyor's line at the loading zone. The EWS is prepared by removing any loose particles from its surface by way of air jets, de-nibbler, brush or the like. This process provides a smooth surface, free from objects that would disrupt the final coated film.

The EWS undergoes pre-treatment by passing it thru a booster oven. This booster oven is preferably IR heating (with or without ORP) but could also be convection heating or a combination IR/Convection. The booster oven raises the EWS temperature to a predetermined level prior to powder coating.

The EWS enters the “dusting” booth where a layer of powder is deposited on one or more of its surfaces. The dusting layer is ideally between 30 and 40 microns, but could be anywhere between 20 and 60 microns. The powder particles adhere to the grounded and warm EWS.

The dust coated EWS passes next through the “green cure” oven where the powder is heated to bring about melting, flow-out and allow partial polymerisation of the powder. This is preferably with IR radiation using ORP.

Following the green cure oven the EWS enters a second powder coating booth where a new layer of powder is deposited on the previously coated surfaces. The new layer is ideally between 50 and 60 microns but could be anywhere between 40 and 80 microns. The powder particles adhere to the grounded and still warm EWS.

The fully coated EWS enters the IR Pulse Plaque Oven configured to provide ORP where the heat is directed to the surface in such a way so as to largely only heat the combined powder layer.

By employing a “Dual Coating” technique (whether within a single or double pass operation), a significant reduction in coating defects is achieved. This reduction in the number of defects ultimately addresses appearance and performance needs. This lowers the overall reject rate of powder coated EWS. By dust coating the EWS first we are sealing the substrate and reducing dehydration of the EWS in order to provide us with an evenly conductive surface for the final coat.

By using this method we are able to achieve repeatedly, uniform and consistent film builds.

The ORP technique was developed to limit heat transfer into the substrate whilst allowing the powder increased dwell time in which to cure. By way of this process the two main issues of supplying a pre-finished totally cured HSS are addressed,

1. Limiting heat build-up in the HSS

2. Provide an environment in which the powder can go through its three states of Melt, Flow and Cure.

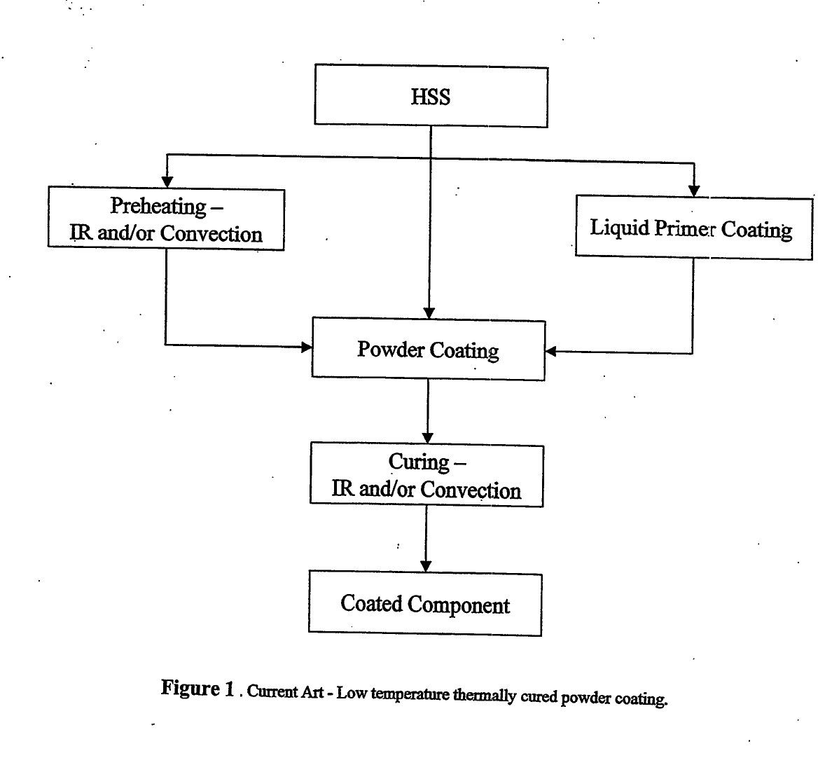

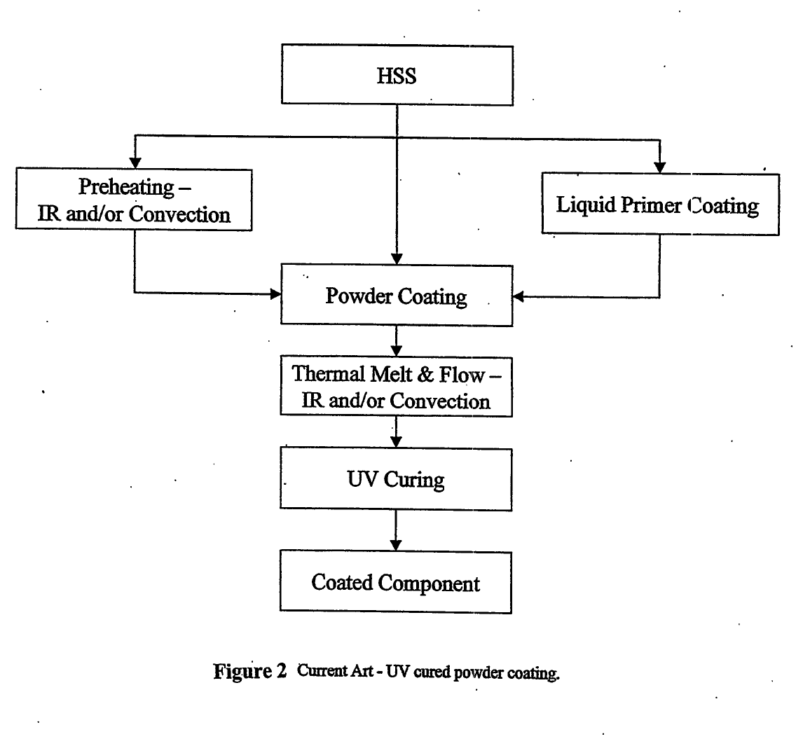

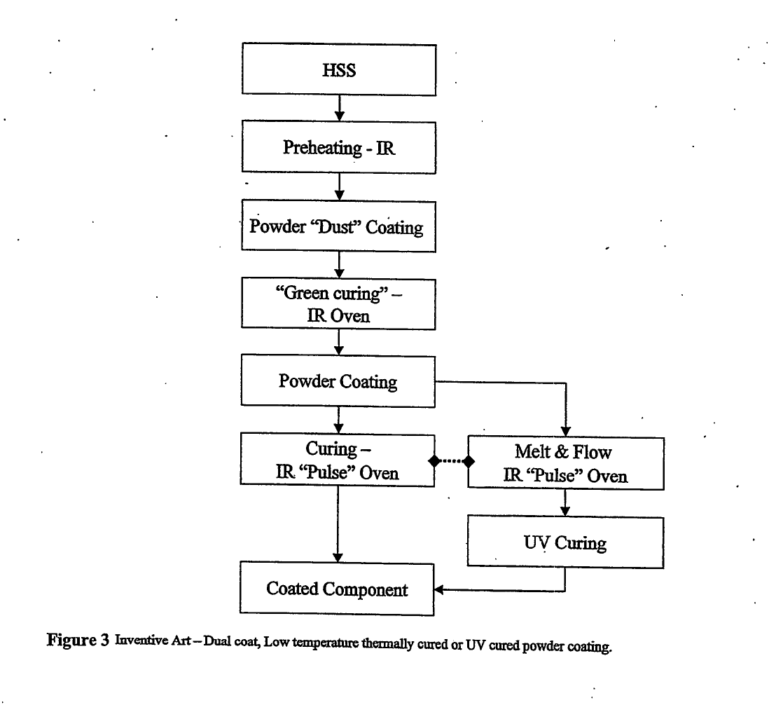

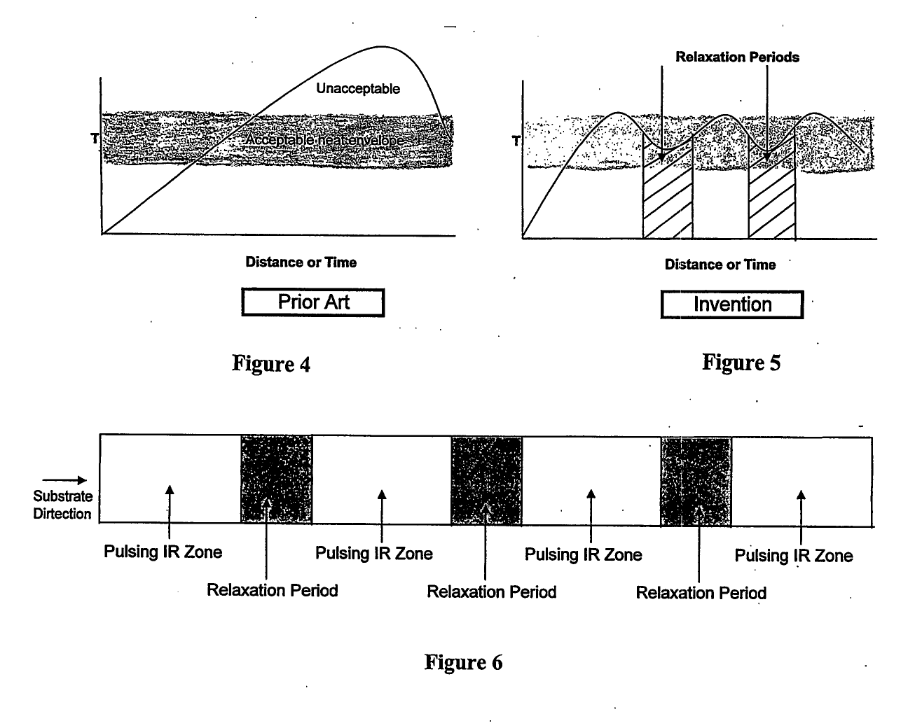

Use of the ORP technique coupled with the particular pulsing plaque layout (FIG. 1) for the IR pulse oven, we lower the heat intensity on the substrate, leaving the integrity of the substrate intact as well as evening the energy out across all six edges of a usual panel type product, which allows us to achieve a uniform cure of the powder.

A process layout, which enables us to apply powder to a wide range of HSS including but not limited to plywood and MDF, is used which will not jeopardise the integrity of the products being processed.

Suitable powders for powder coatings include those available from each of:

Orica Powder Coating Limited 31B Hillside Road Wairau Valley Auckland 1310
Ameron (New Zealand) Limited 5 Monahan Road Mt Wellington Auckland 1006
Dulux Powder Coatings 51 Winterton Road Clayton VIC 3168 Australia
Akzo Nobel Powder Coatings Akzo Nobel Pty Limited 51 McIntyre Road Sunshine, Melbourme Victoria 3020 Australia
DuPont Powder Coatings USA, Inc 9800 Genard Rd. Houston, Tex. 77041 USA
Tigerwerk Lack-u.Farbenfabrick Gmbh & Co. KG Negrellistr. 36 4600 Wels Austria
   Suitable platens include those available from each of platen manufacturers:
Catalytic Industrial Systems 20^{th} and Sycamore Independence, Kans. 67301, USA
Vulcan Catalytic Systems Portsmouth Business Park 207 High Point Road, PO Box 555 Portsmouth, R.I. 02071-0855 USA
Heraeus Noblelight GmbH Heraeusstraβe 12-14 63450 Hanau Germany
Infratech-USA 939 North Vernon Avenue, Azusa Calif. 91702 USA
   Suitable UV sources include those sources available from any of:
Fusion UV Systems, Inc 910 Clopper Road Gaithersburg, MD 20878-1357 USA
Nordson Corp., UV Curing Systems 555 Jackson St. Amherst OH 44001-2496 USA
Heraeus Noblelight GmbH Heraeusstraβe 12-14 63450 Hanau Germany

1-25. (canceled)

26. A method of coating a substrate to provide a product which comprises or includes the steps of
(a) heating the substrate sufficiently to enable its powder coating,
(b) applying a coating of a powder (“the first powder coating”) at least to an entire surface of the sufficiently heated substrate,
(c) partially heat curing the first powder coating on said entire surface,
(d) applying a subsequent powder coating (whether the same type of powder or different) (“the second powder coating”) to the entire surface of the partially cured and still sufficiently heated first powder coating on said entire surface of the substrate, and
(e) either (i) heat curing or (ii) heating and UV curing the second powder coating,
wherein at least steps (b) to (e) occur sequentially whilst the substrate or coated substrate is on a conveyor,
and wherein at least one of
(I) the step (c) partial heat curing of first powder coating, and
(II) the step (e) (i) heat curing or step (e) (ii) heating of at least the second powder coating involves movement of the coated substrate relative to plural fixed infrared (“IR”) radiant heat sources spaced to provide a movement caused pulsing of exposure to the heating effect of such heat sources of the coated surface involved.

27. The method of claim 26 wherein the curing of the second powder coating involves movement relative to plural infrared radiant heat sources.

28. The method of claim 26 wherein the curing of the second powder coating completes the curing of the first powder coating.

29. The method of claim 27 wherein the curing of the second powder coating completes the curing of the first powder coating.

30. The method of claim 26 wherein at least one of the heat sources itself is a pulsing infrared radiant heat source.

31. The method of claim 27 wherein at least one of the heat sources itself is a pulsing infrared radiant heat source.

32. The method of claim 28 wherein at least one of the heat sources itself is a pulsing infrared radiant heat source.

33. The method of claim 29 wherein at least one of the heat sources itself is a pulsing infrared radiant heat source.

34. The method of claim 26 wherein said movement is continuous.

35. The method of claim 26 wherein said movement is continuous.

36. The method of claim 26 wherein said movement is intermittent.

37. The method of claim 27 wherein said movement is intermittent

38. The method of claim 28 wherein said movement is intermittent

39. The method of claim 29 wherein said movement is intermittent

40. The method of claim 26 wherein step (e) is a heat curing step.

41. The method of claim 27 wherein step (e) is a heat curing step.

42. The method of claim 28 wherein step (e) is a heat curing step.

43. Any product being a substrate coated by a method of claim 26.

44. Any product being a substrate coated by a method of claim 27.

45. Any product being a substrate coated by a method of claim 28.
